(19) United States
(12) Patent Application Publication
(10) Pub. No.: US 2011/0291839 A1
(43) Pub. Date: Dec. 1, 2011

(54) CONTROL SYSTEM ACTUATED BY A HUMAN TOUCH FOR FOLDING PARTITIONS

(76) Inventor: Stephen F. COLE, Great River, NY (US)

(21) Appl. No.: 13/105,309

(22) Filed: May 11, 2011

Related U.S. Application Data
(63) Continuation-in-part of application No. 12/788,685, filed on May 27, 2010.

(51) Int. Cl. G08B 23/00

(52) U.S. Cl. 340/573.1

(57) ABSTRACT

An electrically operated folding operable wall is controlled by an electrical operation circuit of the type having at least one control station, an extend control switch, a stack control switch, control relays and a motor. The electrically operated folding operable wall includes a safety system which includes (a) at least one touch sensor selectively responsive to an electrical characteristic of a human body and actuated by operative contact of the human body therewith; and, (b) means for preventing the electrical operation circuit of the folding operable wall from functioning if the touch sensor is not actuated. The preventing means includes at least one control unit electrically connected between each control station of the electrical operation circuit and each touch sensor, which will prevent the control station from functioning if the touch sensor is not actuated by contact with a human body.

### CROSS-REFERENCE TO RELATED APPLICATIONS

The present application is a continuation-in-part of U.S. application Ser. No. 12/788,685, filed May 27, 2010, to which priority is claimed and which is herein incorporated by reference in its entirety.

### BACKGROUND

1.Field of the Invention

The present disclosure generally relates to electrically operated folding partitions, and more particularly to an electrically operated folding partition system which includes a means to verify actuation by a human being and the identity of a user thereof using biometric authentication before the folding partition becomes operable.

2. Background of the Art

Portable folding partitions or walls having a plurality of vertically oriented units have conventionally been used to provide temporary walls to, for example, divide off two or more areas of a given room. In particular, folding portable partitions provide a quick and efficient means to divide large open rooms, such as a school gymnasium or auditorium, into smaller areas. The vertically oriented units are suspended from a horizontal rail system along which the units are movable. In order to facilitate movement of the portable folding partitions, casters or wheels may be provided, which allow the portable partition to be easily positioned to the desired location, and then rolled back into its storage area for later use.

Portable folding partitions have been adapted to include mechanisms which open and close the moving partitions automatically by an electrical system. However, due to the large amount of force needed to move the weight of the folding partitions, electrically operated folding partitions can cause injury, or even death, to a person who accidentally becomes trapped between the partitions. Accordingly, electrically operated folding operable partitions should only be operated by an individual who is adequately trained and qualified to do so.

In order to prevent accidents caused by electrically operated folding partitions, some electrically operated folding partitions have been adapted to include a key which an operator is required to turn, while simultaneously holding a switch, to open or close the folding partition. In theory, these types of electrically operated folding partitions provide an added layer of security over conventional electrically operated folding partitions, because some qualified individual would presumably be watching the partition the entire time it is opening or closing, and hence would stop the folding partition if an object, such as a person, entered the path of the folding partition.

However, this type of electrically operated folding partition can easily be overridden, by, for example, wedging an object in the switch to hold it down, thus allowing the electrically operated folding partition to operate unsupervised. Moreover, the keys used in this type of electrically operated folding partition may be duplicated or stolen, therefore allowing the electrically operated folding partitions to be operated by unauthorized, untrained users. Furthermore, a careless operator who wishes to attend to other matters, may provide the key to an individual who is neither trained nor authorized, thus allowing the unauthorized, untrained individual to operate the electrically operated folding partition.

Accordingly, in order to make electrically operated folding partitions more safe, many states have enacted laws requiring schools to install a safety device that will (a) stop the forward motion of an electrically operated folding partition whenever a person passes between the moving partition and the wall, and (b) stop the partition when a person is present in an area where the partition is being stacked. One such example of this type of electrically operated folding partition is described in U.S. Pat. No. 5,244,030 to Cole et al., the contents of which are incorporated herein by reference. In particular, the electrically operated folding partition described in U.S. Pat. No. 5,244,030 to Cole et al. includes a mechanism for shutting down the electrical operation circuit of the folding operable walls when a physical obstruction interrupts an infrared barrier curtain on opposite sides of an operating path of the folding operable walls.

However, even with electrically operated folding partitions containing automatic reversal sensors or automatic shut-off sensors, there is danger that an undetected individual will become trapped between the folding partitions. Accordingly, many states have enacted laws requiring schools to equip electrically operated folding partitions with two key-operated, tamper-proof, constant pressure control stations that are wired in series, and are remotely located at opposite ends. These requirements ensure that electrically operated folding partitions are designed and constructed so as to require simultaneous activation of both control stations to operate the folding partition. In theory, requiring an operator to be present at each end of the electrically operated folding partition the entire time the electrically operated folding partitions is being operated ensures that someone will be supervising each end of the electrically operated folding partition, and hence will be able to stop the electrically operated folding operable partition should an object, such as a person, enter the path of the folding partition.

However, these types of systems may be overridden or defeated in much the same manner as the electrically operated folding partitions described above, which may be operated with key and switch. Moreover, even with two-key operated electrically operated folding partitions, an authorized operator, such as a school gym teacher or school custodian, may ask someone who is not authorized to operate the electrically operated folding partition for assistance in operating the same, thereby severely compromising the safety of the folding partition. Indeed, conventional electrically operated folding partitions do not provide any means to validate if an operator is authorized to operate the electrically operated folding partition, other than a key, which as discussed above, can easily be compromised.

In general, an individual's identity may be validated by possession-based information, such as a fingerprint or identification card, or by knowledge-based information, such as a password or personal identification number. Many systems used to validate the identity of individuals require an individual to input multiple types of possession-based information, multiple types of knowledge-based information, or combinations of possession-based information and knowledge-based information; in order to enhance security.

U.S. Publication No. 2010/0302001, which is incorporated by reference herein, discloses an electrically operated folding partition system with biometric authentication. Biometrics is the science and technology of measuring and analyzing biological data. Biometric verification is any means by which an individual can be uniquely identified by evaluating one or more distinguishing biological traits. Unique identifiers include fingerprints, facial geometry, hand geometry, earlobe geometry, retina and iris patterns, voice waves, signatures, and keystroke dynamics. In general, biometric verification systems record a person's unique biological traits, which are kept in a database during an enrollment phase. When identification verification is subsequently required, a new record is captured and compared with the records in the database stored in the test phase to estimate the difference between the new record and the stored templates using an algorithm. If the data in the new record matches that in the database record, the person's identity is confirmed.

Biometric authentications systems can be more convenient for the users since there is no password to be forgotten or key to be lost. Biometric characteristics can be divided into physiological biometrics and behavioral biometrics. Physiological biometrics are related to characteristics of one's anatomy, such as fingerprints and hand geometry. Behavior biometrics, on the other hand, are related to an individual's behavior, such as signature verification or keystroke dynamics.

Fingerprint authentication or verification is a physiological biometric which involves verifying a match between two fingerprints, and requires the comparison of several features of the fingerprint pattern. These include patterns which are aggregate characteristics of ridges and minutia points, characteristics found within the fingerprint patterns. The three basic patterns of fingerprint ridges are the arch, loop, and whorl. Minutiae and patterns are very important in the analysis of fingerprints since no two fingerprints have been shown to be identical, even in the case of identical twins. Moreover, because one's fingerprints typically do not change over the lifetime of an individual, fingerprints are a reliable way to identify an individual.

Fingerprint recognition systems have sensors that capture a digital image of the fingerprint pattern. The captured image is typically referred to as a “live scan.” The live scan is digitally processed to create a biometric template, which is stored in a database. When identification verification is subsequently required, a new record is captured and compared with the records in the database. If the data in the new record matches that in the database record, the person's identity is confirmed. A variety of different sensors can be used to capture digital images of fingerprints. Indeed, fingerprint sensors may include, for example: (a) optical sensors which capture a digital image of a fingerprint using visible light; (b) ultrasonic sensors which use the principles of medical ultrasonography to create visual images of the fingerprint; and (c) capacitance sensors which use the principles associated with capacitance to form fingerprint images.

Matching algorithms are used to compare previously stored templates of fingerprints (live scans) against candidate fingerprints for authentication purposes. Pattern-based algorithms compare the basic fingerprint patterns between a previously stored live scan and a candidate fingerprint. The candidate fingerprint image is graphically compared with the template to determine the degree to which they match. If the data in the candidate fingerprint matches the template in the database record, the person's identity is confirmed. It is understood that an exact match is not required to confirm a person's identity. Indeed, substantial matches between the candidate fingerprint and the template (e.g., a 90% or greater match) may be sufficient to confirm a person's identity.

Facial recognition systems are physiological biometric systems which verify a person from a digital image or a video frame from a video source. Facial recognition systems use facial recognition algorithms to identify specific features from a person's face. For example, an algorithm may analyze the relative position, size, and/or shape of the person's eyes, nose, cheekbones, and jaw (facial geometry). 3-D sensors may be used to capture information about the shape of the face. Skin texture may be analyzed to compare unique lines, patterns, and spots apparent in one's skin. This information is then converted into a digital format to provide a mathematical representation of the individual's face (candidate), which is used to search for other images with matching characteristics (e.g., skin texture, shapes and features). If the data in the candidate matches a record in the database record, the person's identity is confirmed. It is understood that an exact match is not required to confirm a person's identity. Indeed, substantial matches between the candidate and a record in the database (e.g., a 90% or greater match) may be sufficient to confirm a person's identity.

Iris recognition is a method of physiological biometric authentication, that uses pattern recognition techniques based on high-resolution images of the iris, which is the colored area that surrounds the pupil. Iris recognition systems use cameras to create images of the intricate concentric circular outer boundaries of the iris and the pupil in a photograph of the eye. When these images are converted into digital templates, they provide mathematical representations of the iris, which are compared against iris images stored in a database. In that iris patterns are unique, comparing a new record to iris structures in a database provides for the unambiguous positive identification of an individual.

Retina recognition is a method of physiological biometric authentication which captures and analyzes the patterns of blood vessels on the thin nerve on the back of the eyeball that processes light entering through the pupil. Retinal patterns are highly distinctive traits. Indeed, every eye has its own unique pattern of blood vessels, even in the case of identical twins. Moreover, a person's pattern of blood vessels typically remains fixed over one's lifetime, therefore making retina recognition a reliable way to identify an individual. Retinal recognition systems convert images of an individual's retinal patterns into digital templates, to provide mathematical representations of the pattern of blood vessels in the retina, which can be compared to retinal patterns stored in a database to yield unambiguous positive identification of an individual.

Hand geometry is a physiological biometric that identifies users by the shape of their hands. Hand geometry recognition systems measure the physical characteristics of a person's hand, including length, width, thickness, and surface area, for example, and compare those measurements to measurements stored in a database. Hand geometry is a reliable means for authentication when combined with other forms of authentication, including knowledge-based information systems.

Ear lobe geometry is a physiological biometric that identifies users by the shape of their ear lobes. Ear lobe geometry recognition systems measure the physical characteristics of a person's ear lobes, and compare those measurements to measurements stored in a database. Ear lobe geometry is a reliable means for authentication when combined with other forms of authentication, including knowledge-based information systems.

Speaker recognition is a type of behavioral biometric which validates a person's identity using characteristics from their voice, and is based on the premise that the acoustic features of speech differ between individuals. Indeed, one's acoustic patterns are a result of both anatomy and learned behaviors. Speaker recognition systems have an enrollment phase and a test phase. In the enrollment phase, the speaker's voice is recorded and a number of features are extracted to form a “voice print.” In the test phase, one's speech is compared against a voice print to determine if the person's voice matches the voice print. If the speech recorded by the individual matches the voice print in the database record, the person's identity is confirmed.

Signature recognition is a type of behavioral biometric which validates a person's identity using characteristics from their signature, and is based on the premise that handwriting characteristics differ between individuals. Indeed, one's handwriting characteristics are a result of both anatomy and learned behaviors. Signature recognition systems have an enrollment phase and a test phase. In the enrollment phase, a person's signature is recorded and analyzed based on a variety of features. In the test phase, the individual's signature is compared against the recorded signature(s) to determine if the person's signature matches the signature saved in the database. If the individual's signature matches a signature in the database record, the person's identity is confirmed.

Keystroke dynamics is a type of behavioral biometric which validates a person's identity using characteristics observed when an individual types on a keyboard, and is based on the premise that the manner in which individuals type on a keyboard differ between individuals. Indeed, the way one types on a keyboard is a result of both anatomy and learned behaviors. Systems which analyze and compare keystroke dynamics systems have an enrollment phase and a test phase. In the enrollment phase, an individual is given a keyboard and asked to type. The individual's keystrokes are recorded and analyzed based on a variety of features. In the test phase, the individual's keystroke dynamics are compared against recorded keystroke dynamics to determine if the person's keystroke dynamics match the keystroke dynamics saved in the database. If the individual's keystroke dynamics matches the keystroke dynamics in the database record, the person's identity is confirmed.

Each of the biometric verification systems described above records a person's unique biological traits, which are kept in a database during an enrollment phase, and then captures a new record when identification verification is required; the verification systems then compare the new record with the records in the database to estimate the distance between the new record and the stored templates using an algorithm. If the data in the new record matches that in the database record, the person's identity is confirmed.

Accordingly, each of the biometric verification systems described above functions to verify the identity of an individual, based on the individual's unique biological traits. It is envisioned that each of the biometric verification systems described above may be coupled to an electrically operated folding partition system to verify the identity of the operator thereof before the electrically operated folding partition becomes operable.

Although the biometric verification systems described above may be coupled to an electrically operated folding partition system to verify the identity of the operator thereof while the electrically operated folding partition is in operation, it is desirable to provide a relatively inexpensive system to ensure that a person is present at each control panel at each of the opposite ends of the folding partition system. Therefore, it would be desirable to provide an electrically operated folding partition system that includes a mechanism to ensure that the electrically operated folding partition will be inoperable unless and until the verification mechanism can verify that the electrically operated folding partition is operated in accordance with the approved safety procedures.

### SUMMARY OF THE INVENTION

An electrically operated folding operable wall is provided herein. The electrically operated folding operable wall is controlled by an electrical operation circuit of the type having at least one control station at each of two opposite ends of the folding wall, each control station including an extend control switch and a stack control switch, and the electrical operation circuit including control relays and a motor for moving the partitions of the folding wall. The electrically operated folding operable wall further includes a safety system which includes (a) at least touch sensor operatively associated with each control station, each touch sensor being selectively responsive to an electrical characteristic of a human body and actuated by operative contact of the human body therewith; and, (b) means for preventing the electrical operation circuit of the folding operable wall from functioning if the touch sensors are not both actuated. The preventing means includes at least one control unit electrically connected between each control station of the electrical operation circuit and each touch sensor, which prevents the control station from functioning if both of the touch sensors are not actuated by contact with a respective human body.

### BRIEF DESCRIPTION OF THE DRAWINGS

Various embodiments are described below with reference to the drawings wherein:

FIG. 1 is a diagramatic elevational view of a capacitive touch switch which is suitable for use in the present invention;

FIG. 2 is a plan view of the capacitive touch switch of FIG. 1;

FIG. 3 is a diagrammatic illustration of a circuit employing the capacitive touch switch of the invention;

FIG. 4 is a perspective view of the control station of one embodiment of the electrically operated folding partition system in accordance with the principles of the present disclosure;

FIG. 5 is a perspective view of the control station of one particular embodiment of the electrically operated folding partition system in accordance with the principles of the present disclosure;

FIG. 6 is a perspective view of the control station of another embodiment of the electrically operated folding partition system in accordance with the principles of the present disclosure;

FIG. 7 is a perspective view of the control station of yet another embodiment of the electrically operated folding partition system in accordance with the principles of the present disclosure; and

FIG. 8 illustrates a folding wall with the safety system of the invention.

Like reference numerals indicate similar parts throughout the figures.

### DETAILED DESCRIPTION OF THE INVENTION

The exemplary embodiments of the system of the subject invention are discussed in terms of electrically operated folding walls or partitions, and more particularly to an electrically operated folding wall system which includes a touch sensor to verify the actual presence of a human operator and authentication means to verify the identity of the operator(s) thereof. It is envisioned that the present disclosure may be employed with electrically operated folding partitions for use with gymnasiums, auditoriums, churches and other places of worship, convention centers, offices, hotels, restaurants, residences, salons, schools, and other buildings having large spaces.

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification and including the appended claims, the singular forms “a,” “an,” and “the” include the plural, and reference to a particular numerical value includes at least that particular value, unless the context clearly dictates otherwise.

Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. Morever, all sub ranges within the given range are considered to be within the scope of the disclosure herein.

All methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

As used herein, “comprising,” “including,” “containing,” “characterized by,” and grammatical equivalents thereof are inclusive or open-ended terms that do not exclude additional, unrecited elements or method steps, but will also be understood to include the more restrictive terms “consisting of and “consisting essentially of.”

All publications, patents and patent applications cited in this specification are herein incorporated by reference in their entirety as if each individual publication, patent or patent application were specifically and individually indicated to be incorporated by reference.

The following discussion includes a description of the system of the subject invention, and related components and exemplary methods of employing the system of the subject invention. Alternate embodiments are also disclosed. Reference will now be made in detail to the exemplary embodiments of the present disclosure, which are illustrated in the accompanying figures.

The control system herein includes a touch sensor responsive to an electrical characteristic of the human body and is actuated by operative contact of the human body with the touch sensor means. In particular, the invention is described below with reference to a capacitive touch switch, although the touch sensor can be responsive to other electrical properties, such as resistance or conductance. Moreover, the actuation of the touch sensor is described in terms of “touch” or “contact” with the finger of the human operator, as this is the normal mode of operation of the control system. However, any operative contact with any portion of the human body is within the scope of the invention. Furthermore, “operative contact” can include the presence of the human body in the vicinity of the touch sensor sufficiently close to actuate the touch sensor, even though not in actual physical contact.

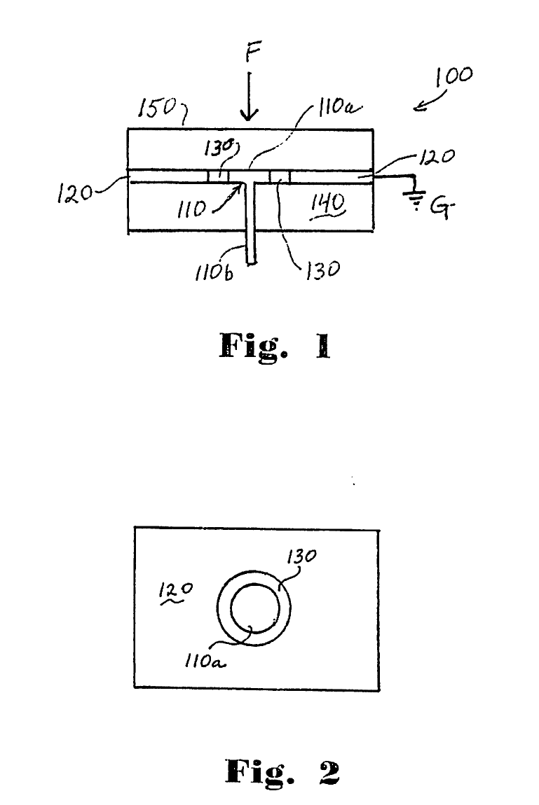

Referring to FIGS. 1 and 2, the control system of the invention includes a capacitive touch switch 100 for use in conjunction with a control panel. Various capacitive touch switches are known in the art and described, for example, in U.S. Pat. Nos. 7,851,720; 7,579,569; 7,232,973; 7,106,221; and U.S. Publication Nos. 2010/0276268; 2010/0109917; and 2009/0107829.

In one embodiment the capacitive touch switch 100 of the invention includes a circuit board having an insulative base 140, such as phenolic plastic, fiberglass, etc. The touch switch 100 includes an electrode 110 and a conductive planar layer 120 connected to ground G and disposed on the upper surface of base 140. The electrode 110 and conductive layer 120 are preferably fabricated from copper, although any other metal or conductive material can be used if appropriate for the purposes described herein. Electrode 110 includes a flat top plate 110a on the surface of base 140 equiplanar with conductive layer 120, and a lead line 110b in electrical connection with the circuit described below. The top plate 110a is preferably circular in shape and separated from the conductive layer 120 by an annular space 130. In an embodiment, the top plate 110a has a diameter of from about 7 to 11 mm, preferably 8 to 10 mm, which is approximately the contact area of a human finger. The annular space 130 separates the outer periphery of the top plate 110a from the corresponding opposite edge of the conductive layer 120 by a distance of from about 1 to 3 mm. The space 130 can be filled with air, or occupied by a dielectric material such as ceramic or glass. The ranges given above are for illustrative purposes and do not constitute limitations of the invention. Dimensions outside these given ranges can be used whenever appropriate for the purposes described herein.

A layer of insulator 150 is disposed over the conductive layer 120 and top plate 110a to provide a dielectric layer between the finger of the operator and the top plate 110a. Preferably, the insulator 150 should have a high dielectric constant and should be as thin as possible to maximize the capacitance created by the touch of a human finger. Insulator 150 is preferably fabricated from polymer (e.g. acrylics, polycarbonate, etc.), glass or ceramic and provides a protective cover for the touch switch 100 which will last for many years under normal conditions. Insulator 150 can optionally include colorants and/or indicia to enhance visual recognition.

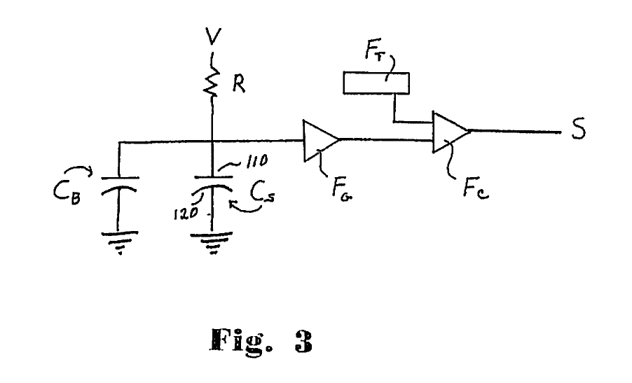

As described more fully below in connection with FIG. 3, a capacitor is formed between the top plate 110a and the conductive layer 120, an electric field being formed across the dielectric of the space 130 when a voltage is applied to the electrode 110. When a person touches the top of the touch switch with a finger F, another capacitance is formed which alters the electric field. This occurs because a human body has a characteristic capacitance. As is well known, a voltage difference between two electrodes separated by a dielectric results in capacitance. In the invention, there is a voltage difference between the charged electrode 110 and the human body (which is grounded) across the dielectric 150. Accordingly, there is a modification in the overall capacitance. This difference can be measured by the appropriate electronic circuitry which can be used to verify that the touch switch 100 is being actuated by a human being.

Referring now to FIG. 3, in one embodiment the difference in capacitance between the unactuated touch switch 100 and the actuated touch switch is determined by a change in frequency. The touch sensor 100 has a capacitance Cₛ which is preselected to be about 8-12 picofarads, and preferably about 10 picofarads. This capacitance is important because the human body has a capacitance C_{B} of from about 5 picofarads to about 15 picofarads. Since the capacitive touch switch detects the difference between the capacitance of the unactuated touch sensor (i.e., Cₛ) and that of the actuated touch switch (Cₛ+Cₛ) the values of Cₛ and C_{B} should not be very different from each other. A voltage V is applied to the circuit as shown through resistor R. A frequency generator, or oscillator F_{G}, generates a signal with a frequency depending on the magnitudes of C₈ and R. When a person touches the touch switch 100, a capacitance C_{B} is introduced in parallel with Cₛ, thereby increasing the overall capacitance which then has a value of Cₛ+C_{B}.

This higher capacitance drops the frequency generated by F_{G}. A threshold frequency is generated by another frequency generator, threshold frequency generator F_{T}. Both the signals from F_{T} and F_{G} are introduced into a frequency comparitor F_{c} which, upon detecting a change in frequency caused by the change in capacitance, generates a signal S to actuate the control mechanism for opening or closing the folding partitions. The system can be either analog or digital and can be made to discriminate between the capacitance of an actual human being and levels of signal noise or excessive capacitance caused by attempts to defeat the system.

Other methods of detection besides frequency comparison can alternatively be employed. For example, voltage measuring systems are known and can alternatively be used to measure the change in capacitance caused by actuation of the touch sensor. The capacitive touch sensor 100 can be used in the control station 12 as described below.

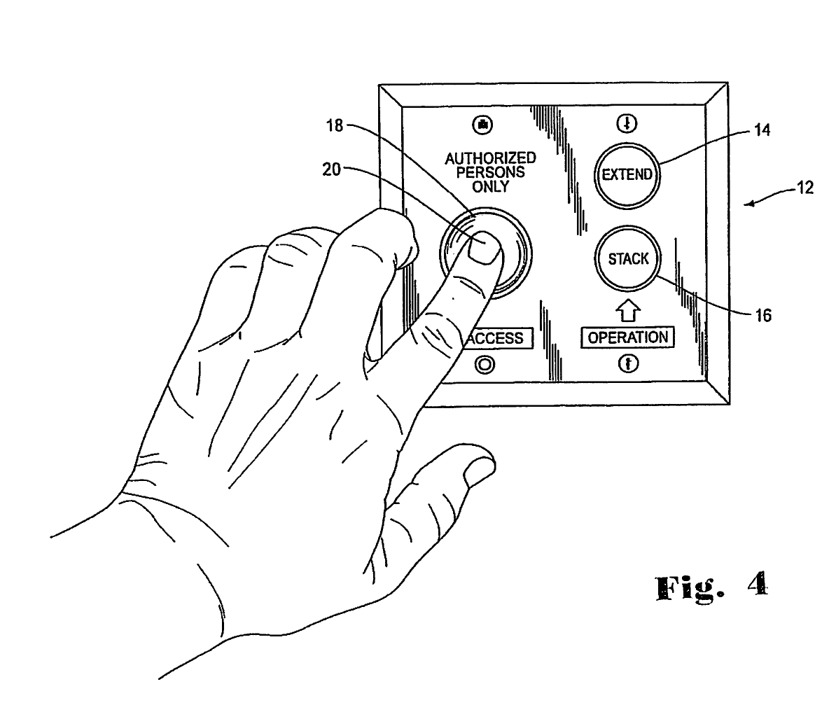

Turning now to FIGS. 4-7, the components of an electrically operated folding wall system, in accordance with the principles of the present disclosure, are illustrated.

The present disclosure provides an electrically operated folding operable wall controlled by an electrical operation circuit of the type having at least one control station 12, an extend control switch 14, a stack control switch 16, control relays and a motor. However, it is understood that extend control switch 14 and stack control switch 16 may be replaced by key switch 22 having a first position 22a and a second position 22b, which is used to stack and extend the electrically operated folding operable wall, respectively, without departing from the spirit of the invention.

In one embodiment, at least one authenticating means 18 authenticates the identity of an operator of the electrically operated folding operable wall, and is/are coupled to control station(s) 12. Authenticating means 18 permits operation of the extend control switch 14 and stack control switch 16 when authentication of the operator is confirmed, and prevents operation of the extend control switch 14 and stack control switch 16 when authentication is not confirmed. In another embodiment, at least one authenticating means 18 is coupled to at least one control station 12 at each end of the folding operable wall. By including at least one authenticating means 18 coupled to a control station 12 on each side of the folding operable wall, the presence of at least two individuals is required, including at least one person at either end of the electrically operated folding wall.

A preventing means prevents the electrical operation circuit of the folding operable wall from functioning if authenticating means 18 fails to authenticate the identity of the operator. The preventing means includes at least one control unit electrically connected between each control station 12 of the electrical operation circuit and each authenticating means 18, which will prevent the electrical operation circuit from functioning if authenticating means 18 fail(s) to authenticate the identity of the operator. Accordingly, the electrically operated folding partition cannot be turned on from an off position (made operable), unless authenticating means 18 can verify the identity of the operator(s) of the electrically operated folding partition.

Moreover, because the preventing means includes at least one control unit electrically connected between each control station 12 of the electrical operation circuit and each authenticating means 18, if authenticating means 18 fail(s) to authenticate the identity of the operator, the electrically operated folding partition will cease to operate (is turned off from an on position).

A restarting means restarts the electrical operation circuit of the folding operable wail after authenticating means 18 successfully authenticates the identity of the operator. In one embodiment, the restarting up means includes a reset control key switch, which when turned on will reactivate the electrical operation circuit and authenticating means 18. Shown in FIG. 7 is a key switch 22 which, in an embodiment, can be used to function alternatively as a reset control station.

In one particular embodiment, authenticating means 18 is a biometric recognition system. Biometric recognition systems identify individuals by evaluating one or more distinguishing biological traits. Unique identifiers include fingerprints, facial geometry, hand geometry, earlobe geometry, retina and iris patterns, voice waves, signatures, and keystroke dynamics. In general, biometric verification systems record a person's unique biological traits, which are kept in a database during an enrollment phase. When identification verification is subsequently required, a new record is captured and compared with the records in the database stored in the test phase to estimate the distance between the new record and the stored templates using an algorithm. If the data in the new record matches that in the database record, the person's identity is confirmed.

As shown in FIGS. 4-7, authenticating means 18 is a fingerprint recognition system. To normally close an electrically operated folding operable wall of an electrically operated folding operable wall system that includes an extend control switch 14 and a stack control switch 16, rather than a key switch, as shown in FIG. 4, the operator must first provide the required biometric information to authenticating means 18. As shown in FIG. 4, the operator is required to place his or her finger 20 on authenticating means 18, which captures an image of the individual's fingerprint and compares the image of the individual's fingerprint with the with fingerprint images in a database. If the image of the individual's fingerprint matches a fingerprint image in the database, the individual's identity is confirmed. Once the individual's identity is confirmed, the operator presses extend control switch 14. Pressing extend control switch 14 will electrically connects extend control switch 14 to control station 12, which will activate the proper control relays and motor. The electrically operated folding operable wall will then close along the operating path and extend to the distal side wall.

To normally open an electrically operated folding operable wall of an electrically operated folding operable wall system that includes an extend control switch 14 and a stack control switch 16, rather than a key switch, as shown in FIG. 4, the operator must first provide the required biometric information to authenticating means 18. As shown in FIG. 4, the operator is required to place his or her finger 20 on authenticating means 18, which captures an image of the individual's fingerprint and compares the image of the individual's fingerprint with the with fingerprint images in a database. If the image of the individual's fingerprint matches a fingerprint image in the database, the individual's identity is confirmed. Once the individual's identity is confirmed, the operator presses stack control switch 16. Pressing stack control switch 16 will electrically connect stack control switch 16 to control station 12, which will activate the proper control relays and motor. The electrically operated folding operable wall will then open along the operating path and stack up to the stacked side wall.

In an embodiment both the extend control switch 14 and the stack control switch 16 are capacitive touch switches such as described above in connection with FIGS. 1-3. Constant finger contact and actuation of extend control switch 14 and stack control switch 16 is required for continued operation.

If authenticating means 18 is unable to verify the identity of the operator, the preventing means will cause the electrically operated folding operable wall to stop. In particular, if authenticating means 18 is unable to verify the identity of the operator, the preventing means will turn off control station 12 and optionally activate a braking mechanism, which in turn stops the motor and halts movement of the folding wall. In order to continue opening or closing the electrically operated folding operable wall, the operator is required to follow the appropriate steps, set forth above.

In one particular embodiment of the present invention, in order to continue opening or closing the electrically operated folding operable wall after the preventing means has caused the electrically operated folding operable wall to stop, the operator is required to activate a reset control station, before following the appropriate steps set forth above for opening and closing. In particular, the reset control station resets the electrical operation circuit and/or control station 12, thus allowing the electrically operated folding operable wall to open and close in the manner described above.

To normally close an electrically operated folding operable wall of an electrically operated folding operable wall system that includes a key switch, rather than an extend control switch 14 and a stack control switch 16, as shown in FIG. 7, the operator must first provide the required biometric information to authenticating means 18. Once the individual's identity is confirmed, the operator turns key switch 22 to a first position 22a while pressing switch 23. Switch 23 is a tamper resistant capacitive touch switch such as described above in connection with FIGS. 1-3 for actuation by the finger of a human operator.

Constant human finger contact with capacitive touch switch 23 is required for operation of key switch 22. Moreover, key switch 22 can be spring biased to a non-operating position so that the operator is required to continually hold the key switch 22 in either the first position 22a or the second position 22b in order to continue the operation of the folding wall. If either the key switch 22 is released or the operator is no longer in finger contact with the capacitive touch switch 23, the preventing means will turn off control station 12 and optionally actuate a braking mechanism to stop the motor and halt movement of the folding wall. After key switch 22 is turned to a first position 22a, key switch 22 will electrically connect through control station 12, which will activate the proper control relays and motor. The electrically operated folding operable wall will then close along the operating path and extend to the distal side wall.

To normally open an electrically operated folding operable wall of an electrically operated folding operable wall system that includes a key switch, rather than an extend control switch 14 and a stack control switch 16, as shown in FIG. 7, the operator must first provide the required biometric information to authenticating means 18. Once the individual's identity is confirmed, the operator turns key switch 22 to a second position 22b while pressing switch 23. After key switch 22 is turned to a second position 22b, key switch 22 will electrically connect through control station 12, which will activate the proper control relays and motor. The electrically operated folding operable wall will then open along the operating path and stack up to the stacked side wall.

If authenticating means 18 is unable to verify the identity of the operator, the preventing means will cause the electrically operated folding operable wall to stop. In particular, if authenticating means 18 is unable to verify the identity of the operator, the preventing means will turn off control station 12 and optionally activate a braking mechanism, which in turn stops the motor and halts movement of the folding wall. In order to continue opening or closing the electrically operated folding operable wall, the operator is required to follow the appropriate steps, set forth above.

In another embodiment, authenticating means 18 verifies the identity of an individual based on both knowledge-based information and biometric characteristics. For example, authenticating means 18 may require that the operator of the electrically operated folding partition enter a personal identification number, for example, in addition to providing the required biological data. Accordingly, by providing an electrically operated folding partition system which includes an authentication system 18 which verifies the identity of an individual based on knowledge-based information and biometric characteristics, two different factors are utilized to verify the identity of an individual, therefore increasing the security of the system.

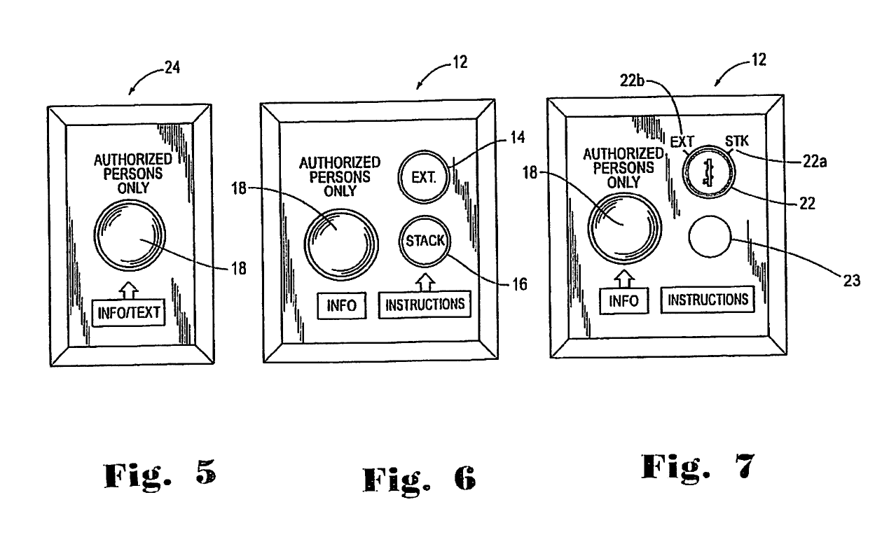

As stated above, the present invention may be used in conjunction with existing electrically operated folding operable wall systems which include, for example, a key switch 22, an extend control switch 14, a stack control switch 16, a control station 12, control relays and a motor, yet lack an authenticating means 18. As shown in FIG. 5, an interface 24 having an authenticating means 18 may be coupled to control station 12 of an existing electrically operated folding operable wall system to facilitate retrofitting to older equipment. In this embodiment the authenticating means 18 can comprise a capacitive touch switch such as described above in connection with FIGS. 1-3 to verify the presence of a human being. Interface 24 permits operation of the extend control switch 14 and stack control switch 16 when authentication of the operator is confirmed, and prevents operation of the extend control switch 14 and stack control switch 16 when verification of human contact is not confirmed.

To normally close an electrically operated folding operable wall having such a system, the operator must have a finger in constant contact with the authenticating means 18 on interface 24, as shown in FIG. 5. With the simultaneous actuation of the capacitive touch switch authenticating means 18 by contact with the individual's finger, the operator either turns a key switch 22 to a first position 22a, or presses an extend control switch 14. Turning key switch 22 to a first position 22a or pressing the extend control switch 14 electrically connects key switch 22 or extend control switch 14 through control station 12, which will activate the proper control relays and motor. The electrically operated folding operable wall will then close along the operating path and extend to the distal side wall.

To normally open an electrically operated folding operable wall having such a system, the operator must have a finger in constant contact with the authenticating means 18 on interface 24, as shown in FIG. 5. With the simultaneous actuation of the capacitive touch switch authenticating means 18 by contact with the individual's finger, the operator either turns a key switch 22 to a second position 22b, or presses a stack control switch 16. Turning key switch 22 to a second position 22b or pressing the stack control switch 16 electrically connects key switch 22 or stack control switch 16 through control station 12, which will activate the proper control relays and motor. The electrically operated folding operable wall will then open along the operating path and stack up to the stacked wall.

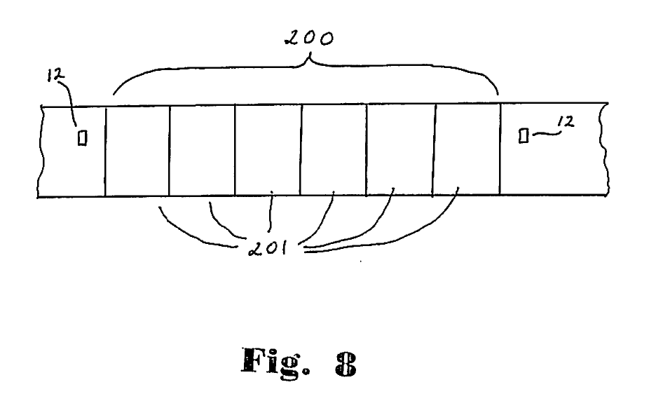

FIG. 8 illustrates a folding wall 200 having multiple partitions 201 which are movable between an extended configuration (as shown) and a stacked configuration wherein the partitions 201 are moved to one end of the folding wall. A control station 12 is positioned on a stationary wall at each of two opposite ends of folding wall 200. Each control station 12 includes a touch sensor such as capacitive touch switch 100, and a stack control means and extend control means. The stack control means and extend control means can be push button switches or can be controlled by a key switch movable between a stack control first position and an extend control second position. Both the touch switch and the stack/extend control means in each control station 12 must be in continual contact with a human being or the movement of the folding wall will cease. This ensures that there will be two persons, one at each end of the folding operable wall, continually present during the operation of the wall.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. An electrically operated folding operable wall controlled by an electrical operation circuit of the type having at least first and second control stations being respectively positioned at opposites ends of the folding operable wall, an extend control means, a stack control means, control relays and a motor, in which the invention being a safety system comprises:
a) at least first and second touch sensors operatively and respectively associated with the first and second control stations, each said touch sensor being selectively responsive to an electrical characteristic of a human body, said first touch sensor being in an actuated condition when in contact with a first human body and an unactuated condition when not in contact with the first human body and said second touch sensor being in an actuated condition when in contact with a second human body and an unactuated condition when not in contact with the second human body; and
b) means for preventing the electrical operation circuit of the folding operable wall from functioning if the touch sensors are not both actuated, wherein the preventing means includes at least one control unit electrically connected between each control station of the electrical operation circuit and each touch sensor, which prevents the control station from functioning if the touch sensors are not actuated by contact with the respective human body.

2. The electrically operated folding operable wall of claim 1 wherein each touch sensor comprises a capacitive touch switch.

3. The electrically operated folding operable wall of claim 2 wherein the capacitive touch switch is electrically connected to an electrical switching circuit capable of determining the change in frequency of an oscillator within the electrical switching circuit caused by the inclusion of a capacitance of the human body in operative contact with the touch sensor.

4. The electrically operated folding operable wall of claim 3 wherein the capacitive touch switch comprises a top plate and a conductive layer separated from the top plate by a dielectric medium, wherein said top plate and conductive layer define a capacitor having a capacitance of from about 8 picofarads to about 12 picofarads.

5. The electrically operated folding operable wall of claim 3 wherein the electrical switching circuit includes a threshold frequency generator and a frequency comparitor, wherein said frequency comparitor generates a signal to actuate the electrical operation circuit for opening or closing the electrically operated folding operable wall in response to actuation of the touch sensor by contact of the capacitive touch switch by a human body.

6. The electrically operated folding operable wall of claim 5 wherein the frequency comparitor is operated in either a digital or analog manner.

7. The electrically operated folding operable wall of claim 2 wherein the capacitive touch switch is electrically connected to an electrical switching circuit which includes a voltage measuring system to determine changes in capacitance caused by actuation of the of the touch sensor by contact of the capacitive touch switch by a human body.

8. The electrically operated folding operable wall of claim 1 further including at least one authenticating means for authenticating the identity of an operator.

9. The electrically operated folding operable wall of claim 8 further including means for preventing the electrical operation circuit of the folding operable wall from functioning if the authenticating means fails to authenticate the identity of the operator, wherein the preventing means includes at least one control unit electrically connected between each control station of the electrical operation circuit and each authenticating means, which will prevent the control station from functioning if the authenticating means fails to authenticate the identity of the operator; and
c) means for restarting up the electrical operation circuit of the folding operable wall after the authenticating means successfully authenticates the identity of the operator, the restarting up means includes a reset control key switch in the at least one control station, which when turned on will reactivate the electrical operation circuit and the authenticating means.

10. The electrically operated folding operable wall of claim 9, wherein at least one authenticating means is a biometric recognition system which compares biometric characteristics.

11. The electrically operated folding operable wall of claim 10, wherein the biometric recognition system is selected from the group consisting of: fingerprint recognition systems, facial recognition systems, earlobe geometry recognition systems, hand geometry recognition systems, iris recognition systems, retina recognition systems, voice recognition systems, signature recognition systems, key stroke recognition systems, and combinations thereof.

12. The electrically operated folding operable wall of claim 9, wherein the authenticating means verifies the identity of an individual based on both knowledge-based information and biometric characteristics.

13. The electrically operated folding operable wall of claim 8 wherein the authenticating means is coupled to the control station at each of the two opposite ends of the folding operable wall.

14. The electrically operated folding operable wall of claim 8 wherein the authenticating means is a fingerprint recognition system.

15. A control system for an electrically operated folding wall which comprises:
a) at least a first control station and a second control station, each of said first control station and second control station being positioned in the vicinity of a respective one of two opposite ends of the folding wall,
wherein each of said first control station and second control station includes a stack control means and an extend control means, and at least one touch sensor for selectively responsive to an electrical characteristic of a human body and actuated by operative contact of the human body therewith;
b) means for electrically connecting the first control station and the second control station in series in an electrical circuit for controlling opening and closing of the folding wall; and
c) means for preventing the electrical operation of the electrical circuit if the touch sensor is not actuated by contact with the human body.

16. The control system of claim 15 wherein the stack control means and the extend control means each individually comprises a push button switch.

17. The control system of claim 15 wherein the stack control means and the extend control means are controlled by a key switch movable between a stack control first position and an extend control second position.

18. The control system of claim 15 wherein the touch sensor comprises a capacitive touch switch.

19. A control system for an electrically operated folding wall which comprises:
a) at least a first control station and a second control station, each of said first control station and second control station being positioned in the vicinity of a respective one of two opposite ends of the folding wall,
wherein each of said first control station and second control station includes a stack control means and an extend control means;
b) means for electrically connecting the first control station and the second control station in series in an electrical circuit for controlling opening and closing of the folding wall;
c) at least one interface panel operatively connected to each of said first control station and said second control station, said interface panel including at least one touch sensor selectively responsive to an electrical characteristic of a human body and actuated by operative contact of the human body therewith; and,
d) means for preventing the electrical operation of the electrical circuit if the verification system is not actuated by contact with the human body.

20. The control system of claim 19 wherein the touch sensor comprises a capacitive touch switch.
